(19) United States
(12) Patent Application Publication
(10) Pub. No.: US 2019/0374314 A1
(43) Pub. Date: Dec. 12, 2019

(54) DOUBLE CONCAVE DRILL FOR DENTAL IMPLANT

(71) Applicant: Chun-Leon CHEN, Taipei City (TW)

(72) Inventor: Chun-Leon CHEN, Taipei City (TW)

(21) Appl. No.: 16/432,574

(22) Filed: Jun. 5, 2019

(30) Foreign Application Priority Data
Jun. 11, 2018 (TW) 107207791

(51) Int. Cl. A61C 8/00

(52) U.S. Cl. CPC A61C 8/0089

(57) ABSTRACT

A double concave drill for dental implant comprising: a shank, an intermediate connecting area, a working section; the shank has a tang part which includes a notch and an annular groove in order to be attached with a dental handpiece; the intermediate connecting area has a colored depth scale to provide for depth marker thus allowing the dentist to accurately position the drill; the working section includes several levels and a cutting tip, the levels have a cutting function, and the diameters of the levels are gradually reduced from the top level downwards, and the cutting tip has a specially designed symmetrical plane for fixing the drilling direction to avoid the drill bit sliding, in addition, one side of the working section and the symmetrical side of it both have a concave extending from an uppermost level to a lowermost level, and each concave and each level form cutting edges.

### TECHNICAL FIELD

The present invention relates to a dental drill and, more particularly, relates to a multi-leveled drill with double concave using in dental implant surgery.

### BACKGROUND OF THE INVENTION

A dental implant is to replace the unhealthy root of tooth with the artificial root (the implant) constructed by titanium or other biocompatible materials and placing the artificial root (the implant) in the alveolar bone at the edentulous position, then putting on a denture to play occlusal function; the artificial root (the implant) used in dental implant cooperate with denture to provide a bite force close to natural teeth, and it is more comfortable and beautiful than the traditional removable denture; as long as you keep the oral cavity clean, it can be used for a long time without changing the implant or denture; for recent years, the success rate has highly improved by the evolution of the materials and techniques, making the dental implant be accepted by more patients.

The implant surgery is to insert a spiral implant into the alveolar bone to support a denture, and after the osseointegration completed, the dentist will install an abutment on the implant, then installing a denture on the abutment, so that the whole implant surgery is completed; the traditional method of dental implant is to locate and drill a pilot hole, then using many drills with different wider diameter to expand the pilot hole gradually until the width and depth near but slightly smaller than the implant; this implant method consumes more than ten drills each time, and drilling repeatedly not only increases the risk of drilling failure but also the risk of infection resulted from the long operation time; moreover, it may become a burden to the dentist because of the high cost of the drill, so some providers invent a fixed-diameter dental pilot drill structure with four cutting edges.

The fixed-diameter dental pilot drill structure has a drill and a stationary ring; the drill includes a shank and a working section, the working section has four cutting edges tapering off to the end, which can drill a hole with setting width and depth by hiding the specific cutting edges with the stationary ring, the shank can combine with the dental handpiece and drive the working section by the high-speed rotation to make the working section drill in the alveolar bone; the stationary ring can cover and hide the specific cutting edges to serve as a limit for the depth of the drilling hole, so the dentist can gradually expand the radius of the hole by taking turns to hide the different cutting edges with the stationary ring during the drilling process, so that the drilling can be completed by consuming only one drill; However, there are several weaknesses of the fixed-diameter dental pilot drill structure, that is, first, it may take a lot of time to replace the stationary rings; second, the stationary ring has no color, which may cause the dentist to inadvertently drill too deeply, causing damage to the patient's facial nerves; third, the drill may easily slide and deviate from the original direction; last, high temperature is generated during drilling, but there is no groove in the drill to allow cold water to enter the hole to cool down, which may cause cell damage or discomfort to the patient.

The present invention has a multi-leveled drill, a specially designing symmetry cutting tip, and double concaves on the side, so it can solve the problems caused by the traditional drill and the fixed-diameter dental pilot drill structure.

### SUMMARY OF THE INVENTION

The purpose of the present invention is to provide a double concave drill for dental implant to solve the problems causing by current drills such as consuming too many drills, direction deviating, high temperature, and difficulty to know the depth.

In order to achieve the above objects, a double concave drill for dental implant comprising: a shank, an intermediate connecting area, a working section; the shank has a tang part which includes a notch and an annular groove in order to be attached with a dental handpiece, which can rotate a drill to cut an alveolar bone by the operation; the intermediate connecting area has a colored depth scale to help the dentist to judge the drilling depth; the working section includes several levels, the diameters of the levels are gradually reduced from the top level downwards, and each of these levels has a cutting function to cut the bones, so it is only necessary to use one drill to complete the drilling, it is not necessary to use several drills to gradually drill holes as in a traditional dental implant procedure, thereby reducing the cost of the drill; the bottom of the working section has a cutting tip with a specially designed symmetrical plane for fixing the drilling direction to avoid the drill sliding, in addition, one side of the working section has the first concave, and the opposite side of it has the second concave, the concaves are extending from an uppermost level to a lowermost level, when the temperature is too high and a dentist sprays water to cool down, cold water can flow from the concaves into the hole to lower the temperature; each concave and each level form several sharp cutting edges which can be used to fix the drilling direction.

### BRIEF DESCRIPTION OF THE DRAWINGS

FIG. 1 is a perspective view of a double concave drill for dental implant in accordance with an embodiment of the present invention.

FIG. 2 is a front view of a double concave drill for dental implant in accordance with an embodiment of the present invention.

FIG. 3 is a rear view of a double concave drill for dental implant in accordance with an embodiment of the present invention.

FIG. 4 is a left side view of a double concave drill for dental implant in accordance with an embodiment of the present invention.

FIG. 5 is a right side view of a double concave drill for dental implant in accordance with an embodiment of the present invention.

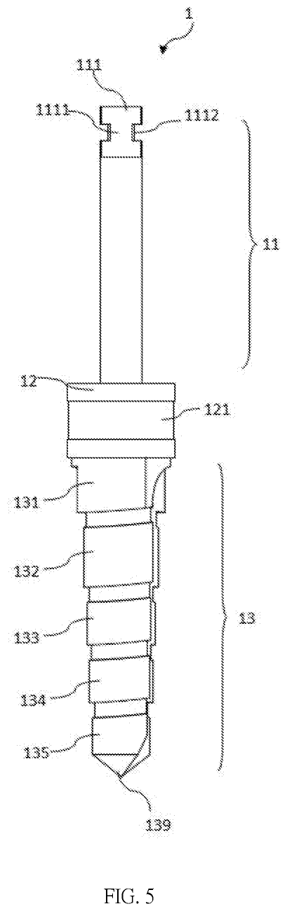

FIG. 6 is a top view of a double concave drill for dental implant in accordance with an embodiment of the present invention.

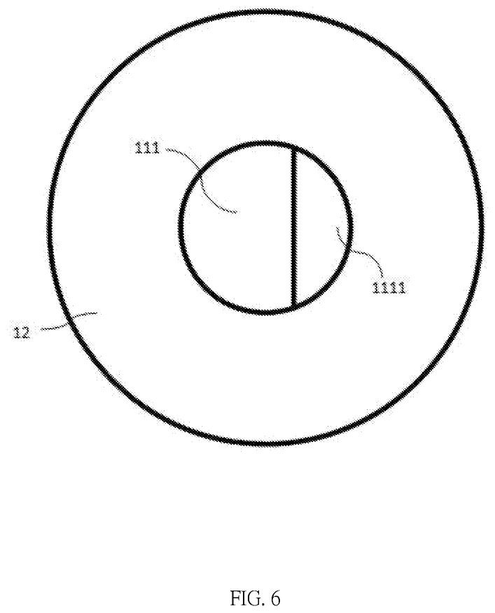

FIG. 7 is a bottom view of a double concave drill for dental implant in accordance with an embodiment of the present invention.

### DETAILED DESCRIPTION OF THE INVENTION

An embodiment of the present invention will be described below with reference to the drawings and the reference numerals, and the proportions of the elements in the embodiment are for exemplary use only, and are not drawn in the proportion of actual elements.

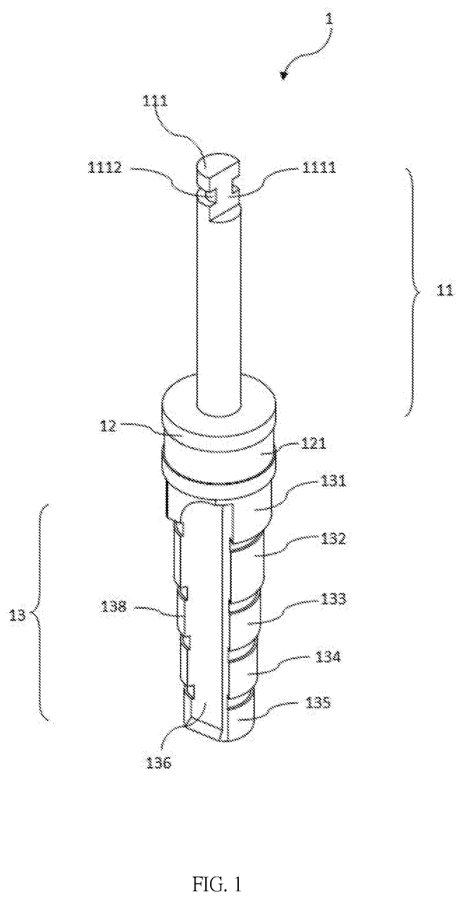

Referring to FIG. 1, a double concave drill for dental implant 1 comprising: a shank 11, an intermediate connecting area 12, a working section 13; the shank 11 is on the top of the intermediate connecting area 12, and the working section 13 is on the bottom of the intermediate connecting area 12; the shank 11 has a tang part 111, the intermediate connecting area 12 has a depth scale 121, and the working section 13 contains five progressively narrower levels, 131, 132, 133, 134, 135, and a cutting tip 139.

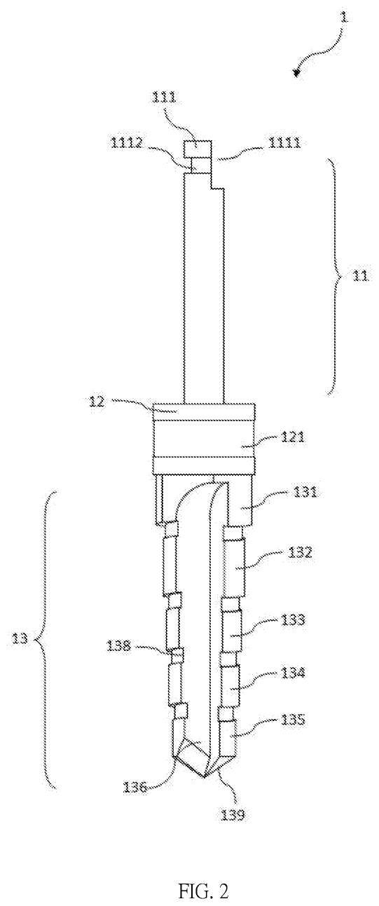

Referring to FIG. 2, the shank 11 has a tang part 111 which includes a notch 1111 and an annular groove 1112 in order to be attached with a dental handpiece, which can rotate a drill to cut an alveolar bone by the operation.

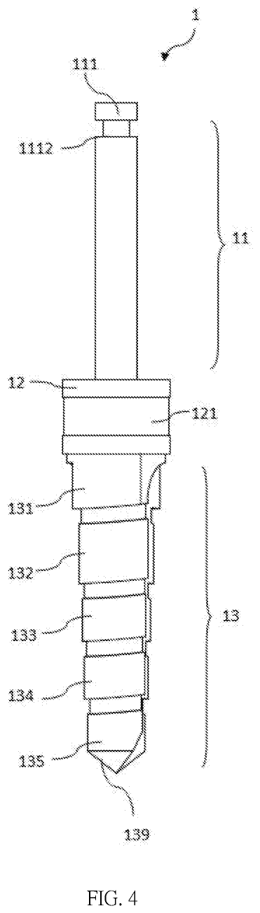

Referring to FIG. 4, the center of the intermediate connecting area 12 has a colored depth scale 121 to help the dentist to judge the drilling depth; when the drill is drilled into the alveolar bone until the depth scale 121 contacts the alveolar bone, it means that the drilling is completed, so as to avoid the drilling being so deep that hurt the facial nerve of the patient or the drilling being too shallow, so that the implant cannot be placed.

Referring to FIG. 2, the levels are listed below in the order of the size of the levels' diameter, from large to small: the first level 131, the second level 132, the third level 133, the fourth level 134, the fifth level 135; each level has a cutting function to cut the bones, as the fifth level 135, the fourth level 134, the third level 133, the second level 132, and the first level 131 are gradually drilled in, the area of the hole is gradually enlarged, so it is only necessary to use one drill to complete the drilling, it is not necessary to use several drills with different diameter to gradually drill holes as in a traditional dental implant procedure, thereby reducing the cost of the drill.

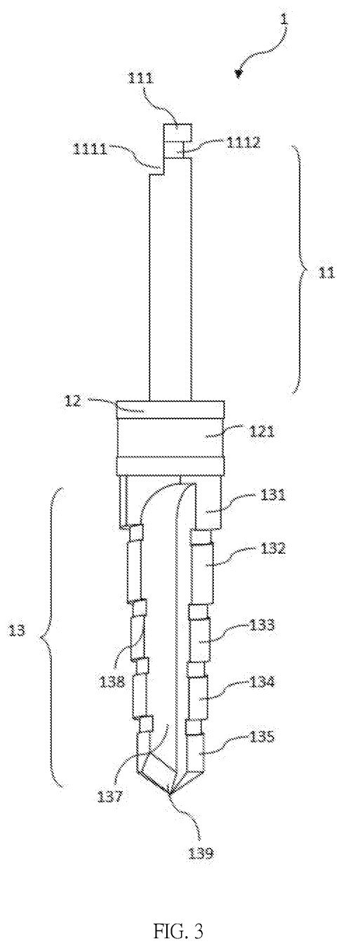

Referring to FIG. 2 and FIG. 3, one side of the working section 13 has the first concave 136, and the opposite side of the working section 13 has the second concave 137, the concaves are extending from the first level 131 to the fifth level 135; when the temperature is too high and a dentist sprays water to cool down, cold water can flow from the concaves into the hole to lower the temperature to avoid the high temperature damaging the cells or making the patients uncomfortable; in addition, the bone chips could jet out of the concaves to avoid them accumulating inside.

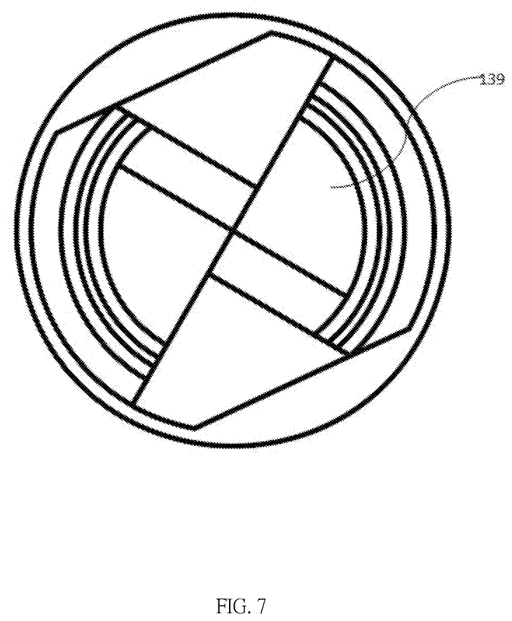

Referring to FIG. 7, when starting drilling the surface of the jaw bone, the cutting tip 139 which has four symmetry planes can fix the direction and avoid the displacement, unlike the normal drill is easy to slide and deviate from the original direction because of the reaction force.

Referring to FIG. 2 and FIG. 3, the first concave 136 and the second concave 137 form four cutting edges 138 by cutting through the first level 131, the second level 132, the third level 133, the fourth level 134, and the fifth level 135; each cutting edge 138 can cut the alveolar bone easily and be used to fix the drilling direction, avoiding the drill deviating from the original path.

While particular embodiment of the invention has been described in considerable detail, it is not intended to restrict or in any way limit the scope of the appended claims to such details, various modification and enhancements may be made without departing from the spirit and scope of the invention.

### REFERENCE NUMERALS LIST

1 . . . double concave drill for dental implant
11 . . . shank
111 . . . tang part
1111 . . . notch
1112 . . . annular groove
12 . . . intermediate connecting area
121 . . . depth scale
13 . . . working section
131 . . . first level
132 . . . second level
133 . . . third level
134 . . . fourth level
135 . . . fifth level
136 . . . first concave
137 . . . second concave
138 . . . Cutting edge
139 . . . Cutting tip

1. A double concave drill for dental implant comprising: a shank, an intermediate connecting area, a working section; the shank is on the top of the intermediate connecting area, and the working section is on the bottom of the intermediate connecting area; the intermediate connecting area has at least one depth scale, and the working section includes at least two levels, two concaves, and a cutting tip.

2. The double concave drill for dental implant according to claim 1, wherein the intermediate connecting area is surrounded by the depth scale to judge the drilling depth.

3. The double concave drill for dental implant according to claim 1, wherein the diameters of the levels are gradually reduced from the upper level to the lower level, the diameter of the level contacting the intermediate connecting area is the largest, and the diameter of the level contacting the cutting tip is the smallest.

4. The double concave drill for dental implant according to claim 1, wherein one side of the working section and its symmetrical side both have a concave extending from an uppermost level to a lowermost level.

5. The double concave drill for dental implant according to claim 3, wherein each concave and each level form at least four cutting edges on the side of the working section.

6. The double concave drill for dental implant according to claim 1, the cutting tip is on the bottom of the working section and has at least one symmetry plane.
